(19) United States
(12) Patent Application Publication
(10) Pub. No.: US 2013/0117998 A1
(43) Pub. Date: May 16, 2013

(54) Telescoping Tower of Wind Turbine

(71) Applicant: Philip Merryman, (US)

(72) Inventor: Philip Merryman, (US)

(21) Appl. No.: 13/295,064

(22) Filed: Nov. 12, 2011

(51) Int. Cl. B23P 11/00

(52) U.S. Cl. 29/592

(57) ABSTRACT

Construction of a Tower of a Wind Turbine from several telescoping sections lifted by compressed gas allows assembly of a Tower at or close to ground level leading to reductions in the personnel, equipment and time necessary to construct the Tower.

### BACKGROUND OF THE INVENTION

Towers of Wind Turbines employing compressed gas to provide lift to the Wind Turbine need innovative designs to take advantage of the reduced material requirements of the Tower. One such design is a Tower that telescopes upwards to the Wind Turbine's desired elevation. This allows for a faster construction of the Tower while at the same time using less material in the construction of the Tower compared to traditional Towers.

### BRIEF SUMMARY OF THE INVENTION

A Tower of a Wind Turbine consists of several sections with successively smaller diameters. The smaller diameter sections are successively located in the interior of the larger diameter Tower sections. The top section of the Tower which has the smallest diameter of the different sections is lifted from the ground by the use of compressed gas pushing upward against the section's ceiling .This in turn eventually lifts the larger diameter sections comprising the lower parts of the Tower. In this way, the Tower of a Wind Turbine extends out of itself, or telescopes, upward until the desired elevation of the Wind Turbine is attained.

### BRIEF DESCRIPTION OF THE VIEWS OF THE DRAWING

FIG. 1.0 shows the telescoping sections of the Tower prior to being lifted by compressed gas from the ground. It shows the top telescoping section contained within the middle telescoping section which is in turn contained within the bottom section of the Tower. FIG. 1.1 shows the telescoping sections extended by the lifting action of the compressed gas to their respective lengths out of the bottom section of the Tower.

### DETAILED DESCRIPTION OF THE INVENTION

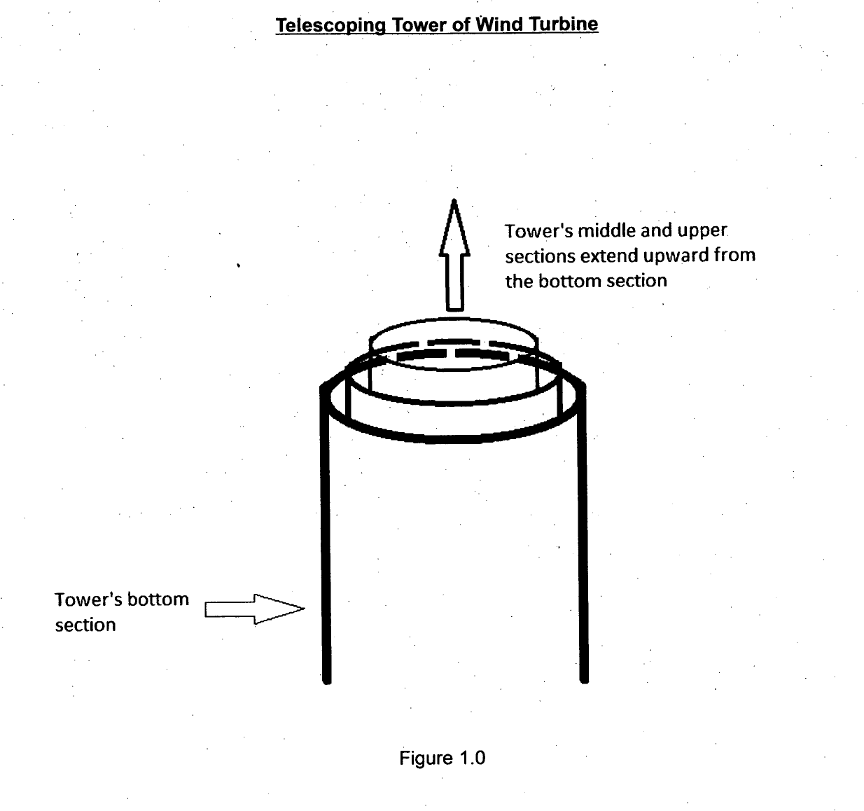

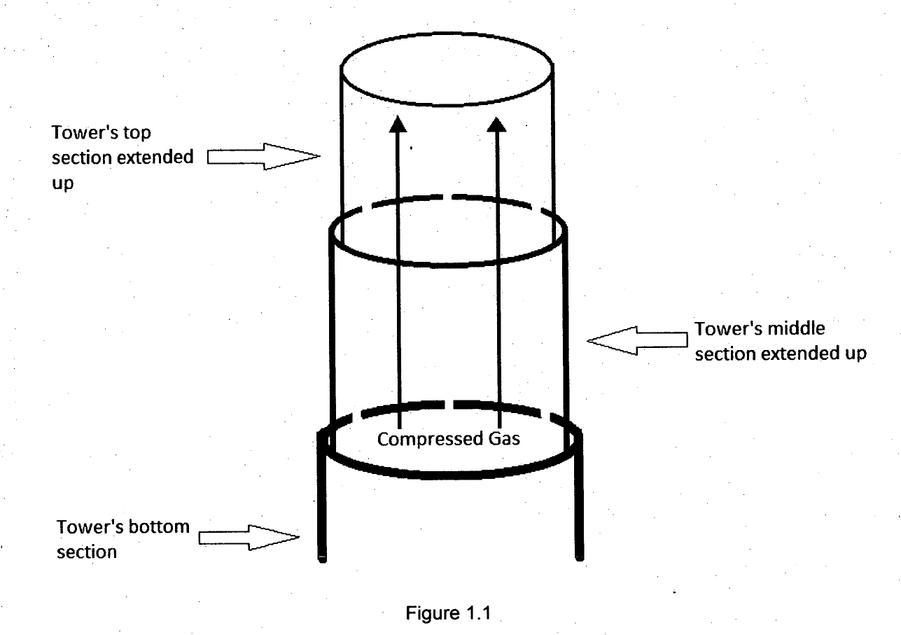

A Tower of a Wind Turbine consists of several sections with successively smaller diameters that slide into each other. When the Tower is empty of compressed gas, the different sections all rest at ground level (FIG. 1.0). When the interior of the Tower is filled with compressed gas of sufficient pressure, the top section of the Tower slides upward due to the upward force exerted by the gas against the section's ceiling. When the top section has fully extended itself, it then lifts the next lower section of the Tower. When the next lower section fully extends itself, it lifts the following lower section. This process continues for as many sections of the Tower there are (excluding the bottom section of the Tower) until the Tower has fully extended, or telescoped, upward from the ground (FIG. 1.1). Prior to the start of this process the Wind Turbine is fitted atop the Tower's top section.

1. The use of compressed gas in conjunction with multiple telescoping sections to erect a Tower of a Wind Turbine by the action of compressed gas lifting the multiple telescoping sections.
